(19) United States
(12) Patent Application Publication
(10) Pub. No.: US 2022/0205743 A1
(43) Pub. Date: Jun. 30, 2022

(54) HOLLOW TUBE WITH VARYING CROSS-SECTIONAL AREA AND METHOD OF MANUFACTURING THE SAME

(71) Applicant: MH TECHNOLOGIES INC., Incheon (KR)

(72) Inventors: Jin-Ho YOO, Seoul (KR); Jung Hoon LEE, Siheung-si (KR)

(73) Assignee: MH TECHNOLOGIES INC., Incheon (KR)

(21) Appl. No.: 17/442,425

(22) PCT Filed: Dec. 30, 2020
(86) PCT No.: PCT/KR2020/019357

§ 371 Date: Oct. 18, 2021

(30) Foreign Application Priority Data
Dec. 29, 2020 (KR) 10-2020-0186553

(51) Int. Cl. F28F 13/08; B22D 25/00

(52) U.S. Cl. CPC F28F 13/08; B22D 25/00

(57) ABSTRACT

A hollow tube with a varying cross-sectional area is disclosed. A hollow tube with a varying cross-sectional area, the hollow tube extending from one end to other end to form a longitudinal direction, the hollow tube comprises a plurality of hollow tube units that are formed to extend along the longitudinal direction and are coupled to each other to constitute the hollow tube, a hollow positioned inside the hollow tube, wherein a cross-sectional area of the hollow varies along the longitudinal direction, and a filling module installed in the hollow.

### TECHNICAL FIELD

The present disclosure relates to a hollow tube with a varying cross-sectional area. More specifically, the present disclosure relates to a hollow tube that varies a cross-sectional area along a longitudinal direction and changes a cooling efficiency for each section.

The present disclosure also relates to a method of manufacturing a hollow tube with a varying cross-sectional area. More specifically, the present disclosure relates to a method of manufacturing a hollow tube capable of assembling each component by unitizing the hollow tube and a filling material inserted into the hollow tube.

### BACKGROUND ART

When a product is molded using a casting method, if a hollow tube is used as a core, a hollow product with a hollow inside can be made. In general, since the hollow tube is manufactured by an extrusion process, a cross-sectional area of the hollow tube is formed uniformly along a longitudinal direction of the hollow tube.

For example, if the hollow product is a motor housing, a motor may be installed inside the hollow product. A temperature of the motor may change depending on a location even inside the motor. In this instance, because the cooling efficiency of all sections of the hollow tube is the same if the cross-sectional area of the hollow tube is uniform, it may be difficult to efficiently cool a portion with a high temperature even inside the motor.

[Patent Document 1] Korean Patent No. 10-1826017

### DISCLOSURE

### Technical Problem

An object of the present disclosure is to address the above-described and other problems.

Another object of the present disclosure is to provide a hollow tube with a varying cross-sectional area along a longitudinal direction.

Another object of the present disclosure is to provide a method of manufacturing a hollow tube with a varying cross-sectional area along a longitudinal direction.

### Technical Solution

In order to achieve the above-described and other objects, in one aspect of the present disclosure, there is provided a hollow tube with a varying cross-sectional area, the hollow tube extending from one end to other end to form a longitudinal direction, the hollow tube comprising a plurality of hollow tube units that are formed to extend along the longitudinal direction and are coupled to each other to constitute the hollow tube, a hollow positioned inside the hollow tube, wherein a cross-sectional area of the hollow varies along the longitudinal direction, and a filling module installed in the hollow.

In another aspect of the present disclosure, there is provided a method (S100) of manufacturing a hollow tube with a varying cross-sectional area, the method (S100) comprising a step (S110) of molding a first filling unit, a step (S120) of molding a plurality of second filling units formed along a longitudinal direction, a step (S130) of surrounding the first filling unit with the plurality of second filling units, a step (S140) of molding a plurality of hollow tube units having a shape extending along the longitudinal direction, a step (S150) of surrounding the plurality of second filling units with the plurality of hollow tube units, and a step (S160) of coupling the plurality of hollow tube units.

### Advantageous Effects

Effects of a hollow tube with a varying cross-sectional area according to the present disclosure are described as follows.

According to at least one embodiment of the present disclosure, the present disclosure can provide a hollow tube including an intensive cooling section having a wider cross-sectional area than other sections.

According to at least one embodiment of the present disclosure, the present disclosure can provide a hollow tube including two hollow tube units that can be coupled to each other.

According to at least one embodiment of the present disclosure, the present disclosure can provide a filling module including one first filling unit and two second filling units capable of surrounding the one first filling unit.

According to at least one embodiment of the present disclosure, the present disclosure can provide a manufacturing of a hollow tube with a varying cross-sectional area by assembling two hollow tube units, one first filling unit, and two second filling units.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### DESCRIPTION OF DRAWINGS

FIG. 1 illustrates a hollow product 100 according to an embodiment of the present disclosure.

FIG. 2 illustrates a hollow tube 200 according to an embodiment of the present disclosure.

FIG. 3 is an exploded cross-sectional view of a hollow tube 200 and a filling module (300) according to an embodiment of the present disclosure.

FIG. 4 is a cross-sectional view of a hollow tube 200 and a filling module 300 according to an embodiment of the present disclosure.

FIG. 5 illustrates a hollow tube 1200 according to another embodiment of the present disclosure.

FIG. 6 is an exploded cross-sectional view of a hollow tube 1200 and a filling module (1300) according to another embodiment of the present disclosure.

FIG. 7 is a cross-sectional view of a hollow tube 1200 and a filling module 1300 according to another embodiment of the present disclosure.

FIG. 8 is a flow chart illustrating a method of manufacturing a hollow tube (200, 1200) with a varying cross-sectional area.

### MODE FOR INVENTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

In the drawings, sizes of the components may be exaggerated or reduced for convenience of explanation. For example, the size and the thickness of each component illustrated in the drawings are arbitrarily illustrated for convenience of explanation, and thus the present disclosure is not limited thereto unless specified as such.

If any embodiment is implementable differently, a specific order of processes may be performed differently from the order described. For example, two consecutively described processes may be performed substantially at the same time, or performed in the order opposite to the described order.

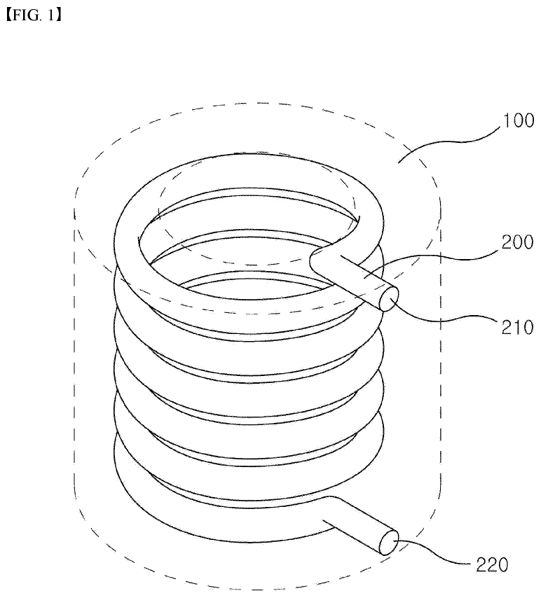

FIG. 1 illustrates a hollow product 100 according to an embodiment of the present disclosure. The hollow product 100 may be made of a cast product including a hollow tube 200. The hollow product 100 may be formed in a cylindrical shape. The hollow tube 200 may be formed to extend from a first side 210 disposed at an upper part of the hollow product 100 to the inside of the hollow product 100. The hollow tube 200 inside the hollow product 100 may be formed to extend along the inside of an outer wall of the hollow product 100. The hollow tube 200 inside the hollow product 100 may have a coil spring shape. The hollow tube 200 inside the hollow product 100 may be formed to extend to a second side 220 disposed at a lower part of the hollow product 100. A longitudinal direction of the hollow tube 200 may be a direction in which the hollow tube 200 extends from the first side 210 to the second side 220.

In order to make the hollow product 100, after the hollow tube 200 is installed inside a mold (not shown), a molten metal may be poured into the mold to mold the hollow product 100. In this instance, in order to prevent the hollow tube 200 from being crushed by a pressure of the molten metal, a filling module 300 may be inserted into the hollow tube 200.

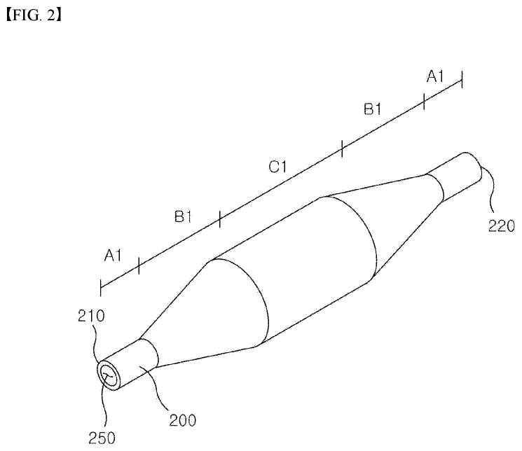

FIG. 2 illustrates the hollow tube 200 according to an embodiment of the present disclosure. The hollow tube 200 may be formed in a circular pipe shape as a whole. A cross-sectional area of the hollow tube 200 may vary along the longitudinal direction. The hollow tube 200 may include a basic cooling section A1, an expansion section B1 connected to the basic cooling section A1, and an intensive cooling section C1 connected to the expansion section B1.

The basic cooling section A1 may have a constant cross-sectional area along the longitudinal direction of the hollow tube 200. The basic cooling section A1 may occupy a high proportion in the hollow tube 200.

A cross-sectional area of the expansion section B1 may vary along the longitudinal direction of the hollow tube 200. At a position at which the expansion section B1 and the basic cooling section A1 are connected, the cross-sectional area of the expansion section B1 may be the same as the cross-sectional area of the basic cooling section A1. The cross-sectional area of the expansion section B1 may widen as the expansion section B1 is far away from the basic cooling section A1 in the longitudinal direction of the hollow tube 200.

The intensive cooling section C1 may have a constant cross-sectional area along the longitudinal direction of the hollow tube 200. Both sides of the intensive cooling section C1 may be connected to the expansion sections B1. At a position at which the intensive cooling section C1 and the expansion section B1 are connected, a cross-sectional area of the intensive cooling section C1 may be the same as the cross-sectional area of the expansion section B1.

The expansion section B1 connected to one side of the intensive cooling section C1 and the expansion section B1 connected to other side of the intensive cooling section C1 may be formed to be symmetric to each other with respect to the intensive cooling section C1. A cross-sectional area of the basic cooling section A1 disposed in a direction of the one side of the intensive cooling section C1 and a cross-sectional area of the basic cooling section A1 disposed in a direction of the other side of the intensive cooling section C1 may be the same as each other with respect to the intensive cooling section C1. That is, the cross-sectional area of the intensive cooling section C1 may be formed to be larger than the cross-sectional area of the basic cooling section A1. When the cross-sectional area of the hollow tube 200 widens, cooling efficiency of the hollow tube 200 can be improved. If the intensive cooling section C1 is disposed near a position at which the hollow product 100 is rapidly heated, the hollow product 100 can be efficiently cooled.

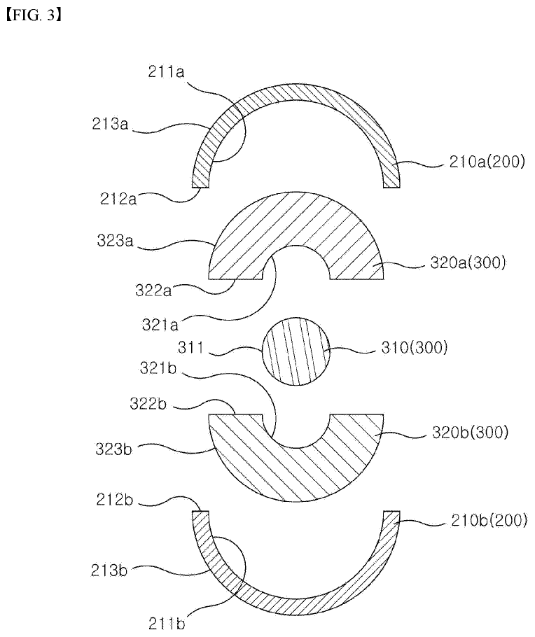

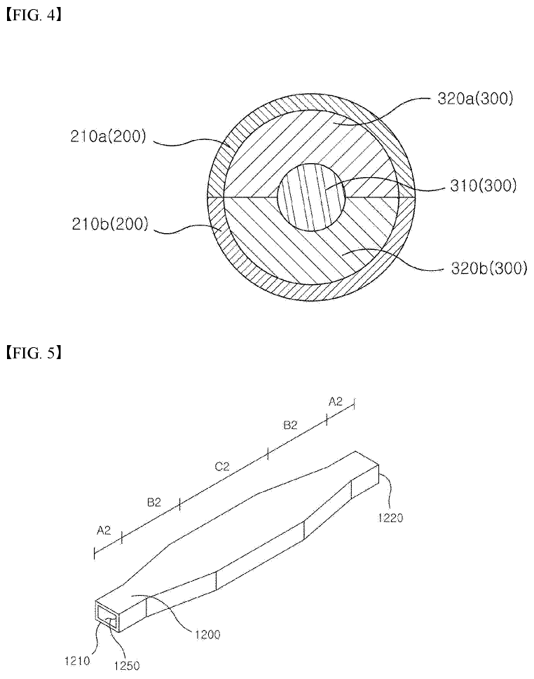

FIG. 3 is an exploded cross-sectional view of a hollow tube 200 and a filling module 300 according to an embodiment of the present disclosure. FIG. 4 is a cross-sectional view of a hollow tube 200 and a filling module 300 according to an embodiment of the present disclosure. A filling module 300 may be disposed inside a hollow 250 of the hollow tube 200. A length of the hollow tube 200 in the longitudinal direction may be the same as a length of the filling module 300 in the longitudinal direction.

The hollow tube 200 may include at least two hollow tube units. The hollow tube 200 may include a hollow tube unit ‘a’ 210a and a hollow tube unit ‘b’ 210b. The hollow tube unit ‘a’ 210a and the hollow tube unit ‘b’ 210b may have a shape in which the hollow tube 200 is cut along the longitudinal direction of the hollow tube 200. The hollow tube unit ‘a’ 210a and the hollow tube unit ‘b’ 210b may have a semicircular arc shape on a plane perpendicular to the longitudinal direction of the hollow tube 200.

The hollow tube unit ‘a’ 210a may include a hollow tube unit ‘a’ inner surface 211a of a semicircular arc shape. The hollow tube unit ‘a’ 210a may include hollow tube unit ‘a’ cut surfaces 212a, and one sides of the hollow tube unit ‘a’ cut surfaces 212a are respectively connected to both ends of the hollow tube unit ‘a’ inner surface 211a and are positioned to be spaced apart from each other in a diameter direction. The hollow tube unit ‘a’ 210a may include a hollow tube unit ‘a’ outer surface 213a of a semicircular arc shape, and both ends of the hollow tube unit ‘a’ outer surface 213a are respectively connected to other sides of the hollow tube unit ‘a’ cut surfaces 212a.

The hollow tube unit ‘b’ 210b may include a hollow tube unit ‘b’ inner surface 211b of a semicircular arc shape. The hollow tube unit ‘b’ 210b may include hollow tube unit ‘b’ cut surfaces 212b, and one sides of the hollow tube unit ‘b’ cut surfaces 212b are respectively connected to both ends of the hollow tube unit ‘b’ inner surface 211b and are positioned to be spaced apart from each other in a diameter direction. The hollow tube unit ‘b’ 210b may include a hollow tube unit ‘b’ outer surface 213b with a semicircular arc shape, and both ends of the hollow tube unit ‘b’ outer surface 213b are respectively connected to other sides of the hollow tube unit ‘b’ cut surfaces 212b.

The hollow tube unit ‘a’ 210a may be disposed on one side of the hollow tube 200 on the plane perpendicular to the longitudinal direction of the hollow tube 200. The hollow tube unit ‘b’ 210b may be disposed on other side of the hollow tube 200 on the plane perpendicular to the longitudinal direction of the hollow tube 200. The hollow tube unit ‘a’ inner surface 211a and the hollow tube unit ‘b’ inner surface 211b may be disposed to face each other.

Both the hollow tube unit ‘a’ cut surfaces 212a and both the hollow tube unit ‘b’ cut surfaces 212b may contact each other. When both the hollow tube unit ‘a’ cut surfaces 212a and both the hollow tube unit ‘b’ cut surfaces 212b are coupled to each other, a shape including the hollow tube unit ‘a’ 210a and the hollow tube unit ‘b’ 210b may have a circular pipe shape. A material of the hollow tube unit ‘a’ 210a and a material of the hollow tube unit ‘b’ 210b may include the same metal material or a non-ferrous metal material. The material of the hollow tube unit ‘a’ 210a and the material of the hollow tube unit ‘b’ 210b may include metal or non-ferrous metal material that can be combined with each other.

The filling module 300 may include a first filling unit 310 and a plurality of second filling units surrounding the outside of the first filling unit 310. The plurality of second filling units may contact the inner surfaces 211a and 211b of the hollow tube 200.

A longitudinal direction of the first filling unit 310 may be the same as the longitudinal direction of the hollow tube 200. The first filling unit 310 may be in the form of a circle on the plane perpendicular to the longitudinal direction of the hollow tube 200.

The first filling unit 310 may include a first filling unit outer surface 311. The first filling unit outer surface 311 may have a circular shape on a plane perpendicular to the longitudinal direction of the first filling unit 310. A diameter of the first filling unit outer surface 311 may be less than a diameter of the inner surface of the hollow tube 200. The diameter of the first filling unit outer surface 311 may be formed uniformly along the longitudinal direction of the first filling unit 310. Hence, it may be easier to remove the first filling unit 310 from the hollow tube 200.

A material of the first filling unit 310 may include inorganic powder or inorganic particles having a porosity of 5% or more and 50% or less. The material of the first filling unit 310 may include metal powder or metal particles having a porosity of 5% or more and 50% or less. The first filling unit 310 may be one mass obtained by compression molding the above-described powder or particles. The first filling unit 310 may maintain its shape by itself.

The plurality of second filling units may include at least two second filling units. The plurality of second filling units may include a second filling unit ‘a’ 320a and a second filling unit ‘b’ 320b. A longitudinal direction of the second filling unit ‘a’ 320a and the second filling unit ‘b’ 320b may be the same as the longitudinal direction of the hollow tube 200. The second filling unit ‘a’ 320a and the second filling unit ‘b’ 320b may have a semicircular arc shape on the plane perpendicular to the longitudinal direction of the hollow tube 200.

The second filling unit ‘a’ 320a may include a second filling unit ‘a’ inner surface 321a of a semicircular arc shape. A diameter of the second filling unit ‘a’ inner surface 321a may be the same as the diameter of the first filling unit outer surface 311. The second filling unit ‘a’ inner surface 321a may contact a part of the first filling unit outer surface 311.

The second filling unit ‘a’ 320a may include second filling unit ‘a’ cut surfaces 322a, and one sides of the second filling unit ‘a’ cut surfaces 322a are respectively connected to both ends of the second filling unit ‘a’ inner surface 321a and are positioned to be spaced apart from each other in a diameter direction.

The second filling unit ‘a’ 320a may include a second filling unit ‘a’ outer surface 323a of a semicircular arc shape, and both ends of the second filling unit ‘a’ outer surface 323a are respectively connected to other sides of the second filling unit ‘a’ cut surfaces 322a. A diameter of the second filling unit ‘a’ outer surface 323a may be the same as the diameter of the inner surfaces 211a and 211b of the hollow tube 200. The second filling unit ‘a’ outer surface 323a may contact a part of the inner surfaces 211a and 211b of the hollow tube 200.

The second filling unit ‘b’ 320b may include a second filling unit ‘b’ inner surface 321b of a semicircular arc shape. A diameter of the second filling unit ‘b’ inner surface 321b may be the same as the diameter of the first filling unit outer surface 311. The second filling unit ‘b’ inner surface 321b may contact a part of the first filling unit outer surface 311.

The second filling unit ‘b’ 320b may include second filling unit ‘b’ cut surfaces 322b, and one sides of the second filling unit ‘b’ cut surfaces 322b are respectively connected to both ends of the second filling unit ‘b’ inner surface 321b and are positioned to be spaced apart from each other in a diameter direction.

The second filling unit ‘b’ 320b may include a second filling unit ‘b’ outer surface 323b of a semicircular arc shape, and both ends of the second filling unit ‘b’ outer surface 323b are respectively connected to other sides of the second filling unit ‘b’ cut surfaces 322b. A diameter of the second filling unit ‘b’ outer surface 323b may be the same as the diameter of the inner surfaces 211a and 211b of the hollow tube 200. The second filling unit ‘b’ outer surface 323b may contact a part of the inner surfaces 211a and 211b of the hollow tube 200.

The second filling unit ‘a’ 320a may be disposed on one sides of the plurality of second filling units on a plane perpendicular to the longitudinal direction of the plurality of second filling units. The second filling unit ‘b’ 320b may be disposed on other sides of the plurality of second filling units on the plane perpendicular to the longitudinal direction of the plurality of second filling units. The second filling unit ‘a’ inner surface 321a and the second filling unit ‘b’ inner surface 321b may be disposed to face each other.

Both the second filling unit ‘a’ cut surfaces 322a and both the second filling unit ‘b’ cut surfaces 322b may contact each other. When both the second filling unit ‘a’ cut surfaces 322a and both the second filling unit ‘b’ cut surfaces 322b are coupled to each other, a shape including the second filling unit ‘a’ 320a and the second filling unit ‘b’ 320b may have a circular pipe shape. That is, a space to which the first filling unit 310 is coupled may be provided inside the second filling unit ‘a’ 320a and the second filling unit ‘b’ 320b.

A material of the second filling unit ‘a’ 320a and a material of the second filling unit ‘b’ 320b may include water-soluble powder or particles having a porosity of 3% or more. Hence, the plurality of second filling units can be easily removed when a water jet is sprayed. Each of the second filling unit ‘a’ 320a and the second filling unit ‘b’ 320b may be one mass obtained by compression molding the above-described powder or particles. Each of the second filling unit ‘a’ 320a and the second filling unit ‘b’ 320b may maintain its shape by itself.

As described above, since the hollow tube unit ‘a’ 210a, the hollow tube unit ‘b’ 210b, the first filling unit 310, the second filling unit ‘a’ 320a, and the second filling unit ‘b’ 320b can be independently formed, each of them can be manufactured and assembled according to the shape of the hollow tube 200 of FIG. 2. That is, the hollow tube unit ‘a’ 210a, the hollow tube unit ‘b’ 210b, the first filling unit 310, the second filling unit ‘a’ 320a, and the second filling unit ‘b’ 320b each may include a basic cooling section A1, an expansion section B1, and an intensive cooling section C1.

FIG. 5 illustrates a hollow tube 1200 according to another embodiment of the present disclosure. The hollow tube 1200 may be formed in a rectangular pipe shape as a whole. A cross-sectional area of the hollow tube 1200 may vary along a longitudinal direction. The hollow tube 1200 may include a basic cooling section A2, an expansion section B2 connected to the basic cooling section A2, and an intensive cooling section C3 connected to the expansion section B2.

The basic cooling section A2 may have a constant cross-sectional area along the longitudinal direction of the hollow tube 1200. The basic cooling section A2 may occupy a high proportion in the hollow tube 1200.

A cross-sectional area of the expansion section B2 may vary along the longitudinal direction of the hollow tube 1200. At a position at which the expansion section B2 and the basic cooling section A2 are connected, the cross-sectional area of the expansion section B2 may be the same as the cross-sectional area of the basic cooling section A2. The cross-sectional area of the expansion section B2 may widen as the expansion section B2 is far away from the basic cooling section A2 in the longitudinal direction of the hollow tube 1200.

The intensive cooling section C3 may have a constant cross-sectional area along the longitudinal direction of the hollow tube 1200. Both sides of the intensive cooling section C3 may be connected to the expansion section B2. At a position at which the intensive cooling section C3 and the expansion section B2 are connected, a cross-sectional area of the intensive cooling section C3 may be the same as the cross-sectional area of the expansion section B2.

The expansion section B2 connected to one side of the intensive cooling section C3 and the expansion section B2 connected to other side of the intensive cooling section C3 may be formed to be symmetric to each other with respect to the intensive cooling section C3. A cross-sectional area of the basic cooling section A2 disposed in a direction of the one side of the intensive cooling section C3 and a cross-sectional area of the basic cooling section A2 disposed in a direction of the other side of the intensive cooling section C3 may be the same as each other with respect to the intensive cooling section C3. That is, the cross-sectional area of the intensive cooling section C3 may be formed to be larger than the cross-sectional area of the basic cooling section A2. When the cross-sectional area of the hollow tube 1200 widens, cooling efficiency of the hollow tube 1200 can be improved. If the intensive cooling section C3 is disposed near a position at which the hollow product 100 is rapidly heated, the hollow product 100 can be efficiently cooled.

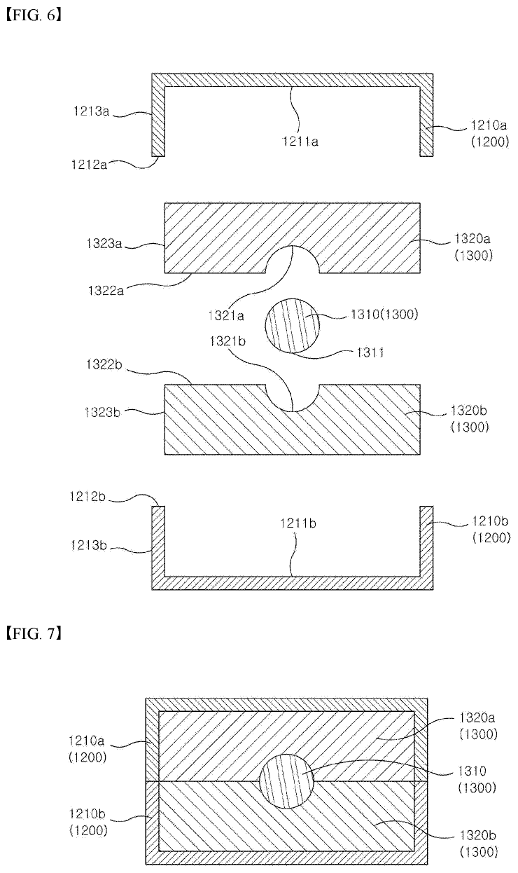

FIG. 6 is an exploded cross-sectional view of a hollow tube 1200 and a filling module 1300 according to another embodiment of the present disclosure. FIG. 7 is a cross-sectional view of a hollow tube 1200 and a filling module 1300 according to another embodiment of the present disclosure. A filling module 1300 may be disposed inside a hollow 1250 of the hollow tube 1200. A length of the hollow tube 1200 in the longitudinal direction may be the same as a length of the filling module 1300 in the longitudinal direction.

The hollow tube 1200 may include at least two hollow tube units. The hollow tube 1200 may include a hollow tube unit ‘a’ 1210a and a hollow tube unit ‘b’ 1210b. The hollow tube unit ‘a’ 1210a and the hollow tube unit ‘b’ 1210b may have a shape in which the hollow tube 1200 is cut along the longitudinal direction of the hollow tube 1200. The hollow tube unit ‘a’ 1210a and the hollow tube unit ‘b’ 1210b may have an angled C-shape on a plane perpendicular to the longitudinal direction of the hollow tube 1200.

The hollow tube unit ‘a’ 1210a may include a hollow tube unit ‘a’ inner surface 1211a of an angled C-shape. The hollow tube unit ‘a’ 1210a may include hollow tube unit ‘a’ cut surfaces 1212a, and one sides of the hollow tube unit ‘a’ cut surfaces 1212a are respectively connected to be perpendicular to both sides of the hollow tube unit ‘a’ inner surface 1211a and are positioned to be spaced apart from each other. The hollow tube unit ‘a’ 1210a may include a hollow tube unit ‘a’ outer surface 1213a of an angled C-shape, and both ends of the hollow tube unit ‘a’ outer surface 1213a are respectively connected to other sides of the hollow tube unit ‘a’ cut surfaces 1212a.

The hollow tube unit ‘b’ 1210b may include a hollow tube unit ‘b’ inner surface 1211b of an angled C-shape. The hollow tube unit ‘b’ 1210b may include hollow tube unit ‘b’ cut surfaces 1212b, and one sides of the hollow tube unit ‘b’ cut surfaces 1212b are respectively connected to be perpendicular to both sides of the hollow tube unit ‘b’ inner surface 1211b and are positioned to be spaced apart from each other. The hollow tube unit ‘b’ 1210b may include a hollow tube unit ‘b’ outer surface 1213b of an angled C-shape, and both ends of the hollow tube unit ‘b’ outer surface 1213b are respectively connected to other sides of the hollow tube unit ‘b’ cut surfaces 1212b.

The hollow tube unit ‘a’ 1210a may be disposed on one side of the hollow tube 1200 on the plane perpendicular to the longitudinal direction of the hollow tube 1200. The hollow tube unit ‘b’ 1210b may be disposed on other side of the hollow tube 1200 on the plane perpendicular to the longitudinal direction of the hollow tube 1200. The hollow tube unit ‘a’ inner surface 1211a and the hollow tube unit ‘b’ inner surface 1211b may be disposed to face each other.

Both the hollow tube unit ‘a’ cut surfaces 1212a and both the hollow tube unit ‘b’ cut surfaces 1212b may contact each other. When both the hollow tube unit ‘a’ cut surfaces 1212a and both the hollow tube unit ‘b’ cut surfaces 1212b are coupled to each other, a shape including the hollow tube unit ‘a’ 1210a and the hollow tube unit ‘b’ 1210b may have a rectangular pipe shape. A material of the hollow tube unit ‘a’ 1210a and a material of the hollow tube unit ‘b’ 1210b may include the same metal material or a non-ferrous metal material. The material of the hollow tube unit ‘a’ 1210a and the material of the hollow tube unit ‘b’ 1210b may include metal or non-ferrous metal material that can be combined with each other.

The filling module 1300 may include a first filling unit 1310 and a plurality of second filling units surrounding the outside of the first filling unit 1310. The plurality of second filling units may contact the inner surfaces 1211a and 1211b of the hollow tube 1200.

A longitudinal direction of the first filling unit 1310 may be the same as the longitudinal direction of the hollow tube 1200. The first filling unit 1310 may be in the form of a circle on the plane perpendicular to the longitudinal direction of the hollow tube 1200.

The first filling unit 1310 may include a first filling unit outer surface 1311. The first filling unit outer surface 1311 may have a circular shape on a plane perpendicular to the longitudinal direction of the first filling unit 1310. A diameter of the first filling unit outer surface 1311 may be small enough so that the first filling unit 1310 is disposed to be spaced apart from the inner surface of the hollow tube 1200. The diameter of the first filling unit outer surface 1311 may be formed uniformly along the longitudinal direction of the first filling unit 1310. Hence, it may be easier to remove the first filling unit 1310 from the hollow tube 1200.

A material of the first filling unit 1310 may include inorganic powder or inorganic particles having a porosity of 5% or more and 50% or less. The material of the first filling unit 1310 may include powder or particles of metal having a porosity of 5% or more and 50% or less. The first filling unit 1310 may be one mass obtained by compression molding the above-described powder or particles. The first filling unit 1310 may maintain its shape by itself.

The plurality of second filling units may include at least two second filling units. The plurality of second filling units may include a second filling unit ‘a’ 1320a and a second filling unit ‘b’ 1320b. A longitudinal direction of the second filling unit ‘a’ 1320a and the second filling unit ‘b’ 1320b may be the same as the longitudinal direction of the hollow tube 1200.

The second filling unit ‘a’ 1320a may include a second filling unit ‘a’ inner surface 1321a of a semicircular arc shape. A diameter of the second filling unit ‘a’ inner surface 1321a may be the same as the diameter of the first filling unit outer surface 1311. The second filling unit ‘a’ inner surface 1321a may contact a part of the first filling unit outer surface 1311.

The second filling unit ‘a’ 1320a may include second filling unit ‘a’ cut surfaces 1322a, and one sides of the second filling unit ‘a’ cut surfaces 1322a are respectively connected to both ends of the second filling unit ‘a’ inner surface 1321a and are positioned to be spaced apart from each other in a diameter direction of the second filling unit ‘a’ inner surface 1321a.

The second filling unit ‘a’ 1320a may include a second filling unit ‘a’ outer surface 1323a of an angled C-shape, and both ends of the second filling unit ‘a’ outer surface 1323a are respectively connected to other sides of the second filling unit ‘a’ cut surfaces 1322a. The shape of the second filling unit ‘a’ outer surface 1323a may be the same as the shape of the hollow tube unit ‘a’ inner surface 1211a. The second filling unit ‘a’ outer surface 1323a may contact the hollow tube unit ‘a’ inner surfaces 1211a and 1211b.

The second filling unit ‘b’ 1320b may include a second filling unit ‘b’ inner surface 1321b of a semicircular arc shape. A diameter of the second filling unit ‘b’ inner surface 1321b may be the same as the diameter of the first filling unit outer surface 1311. The second filling unit ‘b’ inner surface 1321b may contact a part of the first filling unit outer surface 1311.

The second filling unit ‘b’ 1320b may include second filling unit ‘b’ cut surfaces 1322b, and one sides of the second filling unit ‘b’ cut surfaces 1322b are respectively connected to both ends of the second filling unit ‘b’ inner surface 1321b and are positioned to be spaced apart from each other in a diameter direction of the second filling unit ‘b’ inner surface 1321b.

The second filling unit ‘b’ 1320b may include a second filling unit ‘b’ outer surface 1323b of an angled C-shape, and both ends of the second filling unit ‘b’ outer surface 1323b are respectively connected to other sides of the second filling unit ‘b’ cut surfaces 1322b. The shape of the second filling unit ‘b’ outer surface 1323b may be the same as the shape of the hollow tube unit ‘b’ inner surface 1211b. The second filling unit ‘b’ outer surface 1323b may contact the hollow tube unit ‘b’ inner surface 1211b.

The second filling unit ‘a’ 1320a may be disposed on one sides of the plurality of second filling units on a plane perpendicular to the longitudinal direction of the plurality of second filling units. The second filling unit ‘b’ 1320b may be disposed on other sides of the plurality of second filling units on the plane perpendicular to the longitudinal direction of the plurality of second filling units. The second filling unit ‘a’ inner surface 1321a and the second filling unit ‘b’ inner surface 1321b may be disposed to face each other.

Both the second filling unit ‘a’ cut surfaces 1322a and both the second filling unit ‘b’ cut surfaces 1322b may contact each other. When both the second filling unit ‘a’ cut surfaces 1322a and both the second filling unit ‘b’ cut surfaces 1322b are coupled to each other, a shape including the second filling unit ‘a’ 1320a and the second filling unit ‘b’ 1320b may be in the form of a rectangular pipe in which a circular space is formed. That is, a space to which the first filling unit 1310 is coupled may be provided inside the second filling unit ‘a’ 1320a and the second filling unit ‘b’ 1320b.

A material of the second filling unit ‘a’ 1320a and a material of the second filling unit ‘b’ 1320b may include water-soluble powder or particles having a porosity of 3% or more. Hence, the plurality of second filling units can be easily removed when a water jet is sprayed. Each of the second filling unit ‘a’ 1320a and the second filling unit ‘b’ 1320b may be one mass obtained by compression molding the above-described powder or particles. Each of the second filling unit ‘a’ 1320a and the second filling unit ‘b’ 1320b may maintain its shape by itself.

As described above, since the hollow tube unit ‘a’ 1210a, the hollow tube unit ‘b’ 1210b, the first filling unit 1310, the second filling unit ‘a’ 1320a, and the second filling unit ‘b’ 1320b can be independently formed, each of them can be manufactured and assembled according to the shape of the hollow tube 1200 of FIG. 5. That is, the hollow tube unit ‘a’ 1210a, the hollow tube unit ‘b’ 1210b, the first filling unit 1310, the second filling unit ‘a’ 1320a, and the second filling unit ‘b’ 1320b each may include a basic cooling section A2, an expansion section B2, and an intensive cooling section C3.

Unlike the above description, the shapes of the hollow tube units ‘a’ 210a and 1210a, the hollow tube units ‘b’ 210b and 1210b, the first filling units 310 and 1310, the second filling units ‘a’ 320a and 1320a, and the second filling units ‘b’ 320b and 1320b may include an ellipse, a polygon, or the like.

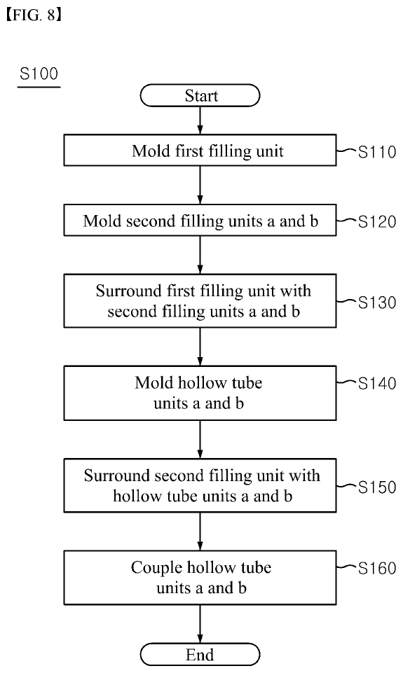

FIG. 8 is a flow chart illustrating a method of manufacturing a hollow tube (200, 1200) with a varying cross-sectional area. FIG. 8 is illustrated and described together with FIGS. 2 to 7. The following is described using a hollow tube 200 according to an embodiment of the present disclosure as an example.

Referring to FIGS. 2 to 7, a method S100 of manufacturing a hollow tube 200 with a varying cross-sectional area may comprise a step S110 of molding a first filling unit 310. In the step S110, the first filling unit 310 as an independent entity may be provided.

The method S100 of manufacturing the hollow tube 200 with the varying cross-sectional area may comprise a step S120 of molding a second filling unit ‘a’ 320a and a second filling unit ‘b’ 320b. In the step S120, the second filling unit ‘a’ 320a and the second filling unit ‘b’ 320b as an independent entity may be provided.

The method S100 of manufacturing the hollow tube 200 with the varying cross-sectional area may comprise a step S130 of surrounding the first filling unit 310 with the second filling unit ‘a’ 320a and the second filling unit ‘b’ 320b. Hence, a filling module 300 including the first filling unit 310, the second filling unit ‘a’ 320a, and the second filling unit ‘b’ 320b may be completed. The second filling unit ‘a’ 320a and the second filling unit ‘b’ 320b do not need to be physically coupled.

The method S100 of manufacturing the hollow tube 200 with the varying cross-sectional area may comprise a step S140 of molding a hollow tube unit ‘a’ 210a and a hollow tube unit ‘b’ 210b. In the step S140, the hollow tube unit ‘a’ 210a and the hollow tube unit ‘b’ 210b as an independent entity may be provided.

The method S100 of manufacturing the hollow tube 200 with the varying cross-sectional area may comprise a step S150 of surrounding the second filling unit ‘a’ 320a and the second filling unit ‘b’ 320b with the hollow tube unit ‘a’ 210a and the hollow tube unit ‘b’ 210b. That is, the filling module 300 may be surrounded by the hollow tube unit ‘a’ 210a and the hollow tube unit ‘b’ 210b.

The method S100 of manufacturing the hollow tube 200 with the varying cross-sectional area may comprise a step S160 of coupling the hollow tube unit ‘a’ 210a and the hollow tube unit ‘b’ 210b. Hence, when the filling module 300 is removed after manufacturing a hollow product 100, the method can prevent a coolant flowing in a hollow 250 of the hollow tube 200 from leaking.

In addition, the method can reduce a gap between an inner wall of the hollow tube 200 and the filling module 300 by pressurizing an outer wall of the hollow tube 200.

Two or more hollow tubes 200 that are manufactured through the above-described method may be coupled. Hence, the present disclosure can form a hollow tube 200 in which two or more intensive cooling sections C1 are arranged in the longitudinal direction of the hollow tube 200.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

1. A hollow tube with a varying cross-sectional area, the hollow tube extending from one end to other end to form a longitudinal direction, the hollow tube comprising:
a plurality of hollow tube units that are formed to extend along the longitudinal direction and are coupled to each other to constitute the hollow tube;
a hollow positioned inside the hollow tube, wherein a cross-sectional area of the hollow varies along the longitudinal direction; and
a filling module installed in the hollow.

2. The hollow tube with the varying cross-sectional area of claim 1, wherein the hollow tube is divided into:
basic cooling sections that are positioned at the one end and the other end, respectively;
an intensive cooling section positioned between both the basic cooling sections; and
expansion sections that connect the intensive cooling section to both the basic cooling sections, respectively,
wherein a cross-sectional area of the hollow in the intensive cooling section is greater than a cross-sectional area of the hollow in the basic cooling sections.

3. The hollow tube with the varying cross-sectional area of claim 2, wherein the basic cooling sections, the expansion sections, and the intensive cooling section communicate each other.

4. The hollow tube with the varying cross-sectional area of claim 1, wherein a cross section of the hollow tube has a circular shape or a polygonal shape.

5. The hollow tube with the varying cross-sectional area of claim 1, wherein the filling module includes:
a first filling unit formed to extend along the longitudinal direction; and
a plurality of second filling units formed to extend along the longitudinal direction,
wherein the plurality of second filling units surround the first filling unit.

6. The hollow tube with the varying cross-sectional area of claim 5, wherein the first filling unit has a constant cross-sectional area along the longitudinal direction.

7. The hollow tube with the varying cross-sectional area of claim 5, wherein outer surfaces of the plurality of second filling units are in contact with inner surfaces of the plurality of hollow tube units.

8. The hollow tube with the varying cross-sectional area of claim 1, wherein the plurality of hollow tube units are formed of the same metal.

9. The hollow tube with the varying cross-sectional area of claim 1, wherein the plurality of hollow tube units are formed of different metals that are able to be combined with each other.

10. The hollow tube with the varying cross-sectional area of claim 5, wherein the first filling unit includes a water-soluble material, and
wherein the plurality of second filling units include an inorganic material or a metal material.

11. The hollow tube with the varying cross-sectional area of claim 10, wherein a porosity of the first filling unit is 3% or more, and
wherein a porosity of the plurality of second filling units is 5% or more and 50% or less.

12. A method (S100) of manufacturing a hollow tube with a varying cross-sectional area, the method (S100) comprising:
a step (S110) of molding a first filling unit;
a step (S120) of molding a plurality of second filling units formed along a longitudinal direction;
a step (S130) of surrounding the first filling unit with the plurality of second filling units;
a step (S140) of molding a plurality of hollow tube units having a shape extending along the longitudinal direction;
a step (S150) of surrounding the plurality of second filling units with the plurality of hollow tube units; and
a step (S160) of coupling the plurality of hollow tube units.
